(19) United States
(12) Patent Application Publication
(10) Pub. No.: US 2017/0249710 A1
(43) Pub. Date: Aug. 31, 2017

(54) EPISODIC SOCIAL NETWORKS

(71) Applicant: The Quantum Group, Inc., Lake Worth, FL (US)

(72) Inventors: Noel J. GUILLAMA, Wellington, FL (US); Jahziel M. GUILLAMA, Wellington, FL (US); Chester HEATH, Boca Raton, FL (US); Carl L. LARSON, Wellington, FL (US); Gregg M. STEINBERG, Northbrook, IL (US)

(21) Appl. No.: 15/592,966

(22) Filed: May 11, 2017

Related U.S. Application Data
(63) Continuation of application No. 14/240,914, filed on Jun. 16, 2014.
(60) Provisional application No. 61/527,287, filed on Aug. 25, 2011.

(51) Int. Cl. G06Q 50/00; G06Q 30/02

(52) U.S. Cl. CPC G06Q 50/01; G06Q 30/0201

(57) ABSTRACT

Systems and methods for delivering augmented user information are provided. A method includes receiving a request for augmented information regarding an entity and obtaining an entity profile for the entity based on activity data from at least one data source and corresponding to one or more activities associated with the entity, the entity profile comprising temporal activity data and non-temporal activity data for the activities. In the method, the entity can be a single user or a group of users. The method also includes identifying one or more episodic social networks (ESNs) associated with the entity, based at least on an episodic social network model and the entity profile, where each of the ESNs associated with a different set of finite temporal boundaries and non-temporal boundaries. The method further includes delivering information regarding the ESNs to a requesting party as the augmented information.

### CROSS-REFERENCE TO RELATED APPLICATIONS

This application is a Continuation of and claims the benefit of §371 National Stage application Ser. No. 14/240,914, filed Jun. 16, 2014 and entitled “Episodic Social Networks”, of International Patent Application No.: PCT/US2012/52404, filed Aug. 25, 2012 and entitled “Episodic Social Networks”, which claims priority to U.S. Provisional Patent Application No. 61/527,287, filed Aug. 25, 2011 and entitled “This application describes a means for creating, managing and enhancing Episodic Social Networks (ESN)”, the contents of all of which are hereby incorporated by reference in their entirety.

### FIELD OF THE INVENTION

The present invention relates to social media and networks, and more specifically to apparatus and methods for means for creating, managing and enhancing episodic social networks.

### BACKGROUND

As of the end of 2011, it has been estimated that social networks are being used by more than 630 million subscribers worldwide and that each individual spends an average of 5.5 hours per month on social networking sites. In addition, various sources have determined that overall social media sites such as FACEBOOK, operated by Facebook Inc. of Menlo Park, Calif. are now the most common homepages for users and that people now spend the majority of their Internet time using social networks or blogs. In fact, only India and China have larger populations than FACEBOOK has users.

Social network websites continue to grow on a huge scale with recently reaching over 400 million worldwide users. Other social media websites have observed similar growth. For example, TWITTER, operated by Twitter Inc. of San Francisco, Calif., is approaching the benchmark of 50 million “tweets” per day. FACEBOOK and TWITTER growth has continued to a point that social networking now accounts for 11% of all time spent online. Additional findings regarding adults using social media include: (1) a third of these adults post at least once a week to social sites such as FACEBOOK and TWITTER; (2) a quarter of these adults publish a blog and upload video/audio they created; (3) nearly 60% of these adults maintain a profile on a social networking site; and (4) 70% of these adults read blogs, tweets and watch User Generated Content (UGC) video.

However, attempts to monetize the huge community of users on these social networking sites have met with limited success. For example, deal of the day websites, such as GROUPON, operated by Groupon, Inc. of Chicago, Ill., and LIVINGS OCTAL, operated by LivingSocial Inc. of Washington, D.C., have seen some success because of the attraction of local businesses to the possible dual benefit. First, a local business has a guaranteed sale for their products or services, reducing excess capacity and attaining economies of scale. Second, and ideally more important, is the word-of-mouth for new products and services that help attract additional customers. However, the ideal real long-term advantage gained through low-cost discount coupons is in attracting new customers and then retaining them for repeat business.

Unfortunately, while the low-cost discount coupon business model attracts new customers to a business, it does not necessarily translate into retention of these customers. Further, a business model based solely on selling coupons over the internet is simple and easily replicated. As a result, such a model is not sustainable for two at least two reasons: (1) deal of the day websites are ultimately selling other companies' products that have the upper hand in any deal negotiations, and 2) these websites have competition from direct offerings from companies and from other web-based companies with a broad user base. If fact the competition can come from the business these websites are promoting.

Another attempt at monetizing social networks is relying on a location based services (LBS), as offered by FACEBOOK and others. That is, allowing users to “check-in” with their current location so that individuals on their “friends” list can see where they are or where they have been. The principle revenue channel for these companies is through “pop-up” advertising on active pages. Alternatively, such information can be used to track the location behavior of potential customers to provide more targeted advertising. However, such services face obstacles similar to those encountered by deal of the day websites. Namely, these services allow the attraction of new customers to a business yet do not provide a means for retaining these new customers.

### SUMMARY

Embodiments of the invention concern systems, methods, and computer-readable mediums for delivering augmented user information based on episodic social networks (ESNs). In one embodiment of the invention, a method is provided. The method includes receiving a request for augmented information regarding an entity and obtaining an entity profile for the entity based on activity data from at least one data source and corresponding to one or more activities associated with the entity, the entity profile comprising temporal activity data and non-temporal activity data for the activities. In the method, the entity can be a single user or a group of users. The method also includes identifying one or more ESNs associated with the entity, based at least on an episodic social network model and the entity profile, where each of the ESNs associated with a different set of finite temporal boundaries and non-temporal boundaries. The method further includes delivering information regarding the ESNs to a requesting party as the augmented information.

The method can also include projecting, based at least on the episodic social network model, a plurality of future ESNs for the entity and conditions for transitioning from a most recent one of the ESNs to each of the plurality of future ESNs to yield supplemental information and supplementing the augmented information further with the supplemental information.

The request can include target activity for the entity. In such cases. The method can also include adjusting, prior to the supplementing, the supplemental information to exclude a portion of the plurality of future ESNs that fail to include the target activity.

The request can further include at least one target condition type. In such cases, the method includes adjusting, prior to the supplementing, the supplemental information to exclude a portion of the plurality of future ESNs not associated with the at least one target condition type.

The identifying step in the method can include selecting the ESNs to be contextually relevant to the requesting party. The non-temporal activity data can include activity detail data, geo-location data, demographic data, even genetic or personality profile simulation and analysis.

The method can further include deriving the episodic social network model, where the episodic social network model comprising a plurality of episode types and at least one condition for transitioning between episode types. The deriving can include obtaining aggregate activity data for a plurality of activities associated with a plurality of entities, the aggregate activity data comprising temporal activity data and non-temporal activity data. The deriving can further include identifying the plurality of episodes from the aggregate activity data, each of the plurality of episodes associated with a finite temporal boundary and at least one non-temporal boundary. This identifying can be based on a segmentation analysis. The deriving can also include determining a plurality of paths associated with the plurality of episodes, where each of the plurality of paths is a substantially temporal sequence of a portion of the plurality of episodes associated with at least one of the plurality of entities. The deriving can also include, based on the aggregate activity data, identifying the at least one condition required for causing a transition between the proximal episodes in each of the plurality of paths.

In another embodiment, a method is provided for a partner system to manage at least one entity of interest. This method can include receiving augmented information for the at least one entity, the augmented information comprising at least an episodic social network (ESN) currently associated with the at least one entity and bounded by a set of finite temporal boundaries and at least one set of non-temporal boundaries, a plurality of future ESNs for the at least one entity from the at least one ESN currently associated with the at least one entity, and future conditions required for transitioning to each of the plurality of future ESNs. The method can also include selecting at least one of the plurality of future ESNs based on a selection criteria to yield selected ESNs and generating the future conditions associated with the selected ESNs.

In some embodiments, this method can further include receiving at least one episodic social network model comprising a plurality of ESNs and a plurality of transitions associated with the plurality of ESNs, each of the ESNs associated with a different set of finite temporal boundaries and finite non-temporal boundaries, each of the plurality of transitions associated with a first and a second of the plurality ESNs and identifying conditions for transitioning between the first and the second of the plurality of ESNs. In such embodiments, the plurality of future ESNs and the future conditions are selected based from the at least one episodic social network model.

In the method, the redirection criteria can include selecting the selected ESNs from the plurality of future ESNs that provide an advantage to the partner system or an affiliate of the partner system. Specifically, the advantage can be a financial advantage.

The generating of conditions in the method can include providing at least one of guidance, an incentive, or a recommendation to the at least one entity for causing the future conditions to occur. Further, the selected ESNs can include at least two of the plurality of future ESNs. Thus, the selecting can further include ranking the selected ESNs based on a ranking criteria at the partner system. Additionally, the providing can further include biasing the at least one of the guidance, the incentive, or the recommendation for each of the selected ESNs to favor higher ranking ones of the selected ESNs.

In some embodiments, the at least one of the guidance, the incentive, of the recommendation can include pursing an association with at least one other entity. Thus, the method can include providing at least one of guidance, an incentive, or a recommendation to the at least one other entity to pursue the association.

Other embodiments are directed to systems for carrying out the methods described above and computer-readable mediums including instructions for causing the methods described above to be performed.

### BRIEF DESCRIPTION OF THE DRAWINGS

FIG. 1 is a schematic diagram of an episode in accordance with the various embodiments;

FIG. 2A illustrates a configuration for an exemplary system in accordance with the various embodiments in which electronic devices communicate via a network for purposes of exchanging content and other data;

FIG. 2B is a logical diagram showing how data flows in the system of FIG. 2A;

FIG. 3 is a flowchart of steps in an exemplary method for using augmented information in accordance with the various embodiments;

FIG. 4 is a flowchart of steps in an exemplary method for generating a model in accordance with the various embodiments;

FIG. 5 is a flowchart of steps in an exemplary method for processing requests for augmented user information in accordance with the various embodiments;

FIG. 6 is a flowchart of steps for collecting data and allocating resources in accordance with the various embodiments; and

FIG. 7 is illustrates and exemplary computer system for carrying out any of the methods described herein.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

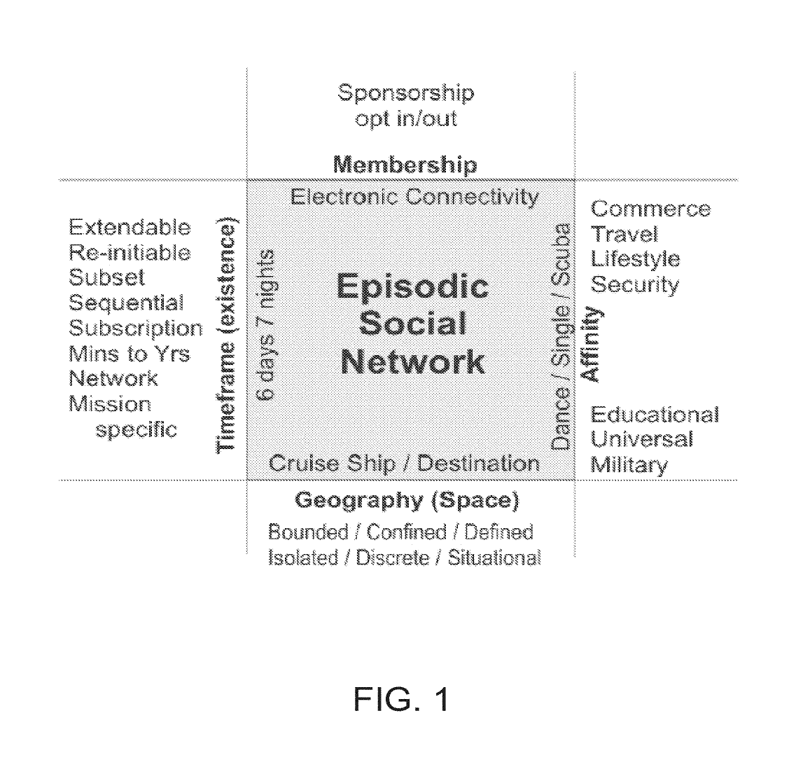

As discussed above, effective monetization of social networks has generally been difficult to accomplish. In particular, a key failure of these attempts has been how a business attracting new customers can retain these new customers. In view of the limitations of conventional social network monetization schemes, the various embodiments provide a new methodology for monetization of social networks. In particular, the various embodiments provide for utilizing the concept of episodic social networks (ESNs) to provide goods and services to users. This concept is illustrated with respect to FIG. 1. FIG. 1 is a schematic diagram of an episode in accordance with the various embodiments.

Many activities (or sets thereof) can be considered “episodes” where these activities occur within a time boundary or a short-lived envelope of time. In general, the time boundary may be on any scale from microseconds to years, but it is ultimately finite. In some cases, an episode may reoccur or be a subset of a larger more complex episode. In some cases, it may even be extendable. For example, a time boundary can be defined by a subscription period that is extendable or renewable. However, an episode is ultimately finite and discrete.

In additional to a time boundary, the activities defining an episode will also have non-temporal characteristics that characterize the episode. For example, activities associated with an episode can be associated with a particular membership. For a particular episode, this membership might be open ended, open to all citizens, or part of a large group, such as employees of a business. Alternatively one might become a member by engaging in an activity prior to the episode. For example, one can become a member of a warehouse buying club for example in a commerce situation where one is allowed to buy. A common aspect of such membership is that the members are bounded by a common envelope of rules.

In another example, activities associated with an episode can also be associated with a particular geography. That is, members are generally engaging in an activity associated with a same place, such as building, ship, street, or mall, such that the members may interact with each other. A trip to the car dealer for maintenance of one's car might be seen as an episode where experts on the vehicle, join with the owner, and various trade specialists, for a period of perhaps an hour within a service facility. Alternatively, the geography may be virtual. That is, the members engaging in a particular discussion on an online forum, playing online games, or a chat session. Further, the users need not be static. Thus, members can be in motion, such as in a vehicle or simply walking or running.

The activities associated with such an episode will also generally have some affinity. That is, the objectives of the members will align along some common purpose, interest, or theme. This does not necessarily require each of the members have the same objective, but rather that the objectives of the different members align along some the common purpose. For example, referring back to the car dealer example above, a customer may have the objective to obtain repairs as quickly as possible and at the lowest cost possible. The trade specialists associated with the dealer may have other objectives, such as achieving a level customer satisfaction, selling more services or commodities (cars and accessories in this case), to make a profit, or any combination thereof. While the objectives of the customer and the trade specialists can be considered to be contrary to each other, they are still aligned along the common purpose of addressing the customer's maintenance issues with his vehicle and putting him back on the road, whether in the same vehicle or a new vehicle.

In another example, the affinity can be based on individuals engaging in a same, similar, or related act of commerce, who share a lifestyle, may be traveling to a common destination, who might share a common security situation as all protected by a common insurance carrier. For example, the affinity may be between those with a common education, or attend a common school. It may be between members who purpose is military defense, emergency response or medical aid. In other words, the members associated with the episode have something, typically a purpose in common.

Referring back to FIG. 1, an example of such an episode associated with a set of passengers on cruise is when a set of temporal and non-temporal characteristics coincide, such as:

a. Timeframe: The six days and seven nights of a particular cruise;
b. Geography: The cruise occurs on a particular cruise ship and/or is associated with a particular destination;
c. Membership: Passengers having electronic connectivity; and
d. Affinity: Passengers who are single and like dancing and scuba.
The example of FIG. 1 is provided solely for illustrative purposes. In the various embodiments, episodes can also be characterized based on other non-temporal characteristics not described above or any combinations thereof.

Based on the foregoing, the types of episodes described above can be considered to define ad-hoc social networks. That is, for a moment in time, users associated with an episode can be perceived as coming together to form a temporary social network or ESN. ESNs therefore provide a new way to perceive, track, and manage users. Thus, from a business perspective, ESNs also provide a new way to manage how a business can provide goods and service and how a business can manage transactions, especially service oriented business transactions, for the benefit of the group.

One aspect of ESNs is that can form in various ways. For example, ESNs can exist simultaneously (completely or partially) or sequentially in time. Further, ESNs can re-occur periodically or randomly on a demand basis. Alternatively, they can occur a single time and never repeat.

The main differentiator between an ESN and a traditional social network is that the ESN will always have a temporal boundary (i.e., bounded and finite in time) and have one or more non-temporal boundaries, such as space, membership, and affinity of purpose. For example, a hospital can be considered as existing indefinitely, but those individuals assembled in the operating room for a common purpose (e.g., a particular surgery or procedure) can be considered to form an ESN that exists only for the duration of the mission or the common purpose is achieved. Further, an ESN associated with a complex mission, such as a heart bypass operation, can be perceived as consisting of a collection of smaller episodes. These can include anesthetizing the patient, opening the chest wall, individual vein removal and repurposing, closure, and recovery activities. Further, ESNs may be nested inside a larger ESN.

The various embodiments of the invention advantageously use such ESNs to determine how to provide goods and services to users. In particular, the various embodiments utilize user data from various sources to identify ESNs and to observe how the ESNs develop over time. Accordingly, ESNs in accordance with the various embodiments not only provide a new method for tracking activities associated with users, but these ESNs can also be used in the various embodiments to build models for predicting future ESNs for the users. More importantly, the ESNs and associated models can also be utilized to identify the factors or conditions resulting in users engaging in particular ESNs. From a goods and services standpoint, such modeling then allows a business to determine what inputs can be provided to users to drive them towards a particular ESN. Thus, a business could potentially contrive the necessary conditions for driving users to an ESN. For example, referring to the GROUPON scenario, such modeling can be utilized to determine what should be provided to new customers in order to retain the customers.

In conventional modeling by businesses, they generally rely on a limited set of data with regards to a particular user. For example, when a new customer arrives, the business obtains the information necessary for the new customers' transaction. In some cases, businesses can obtain some additional information by way of surveys and similar data collection methods. Thereafter, the business can look to data for multiple users to detect trends among their customers and try to identify the best way to retain such customers. Unfortunately, these data collection schemes are of limited utility for customer retention as they effectively look a user data associated with only one moment in time, i.e., only a snapshot in time regarding the user. Further, the user's responses to the data collection efforts may have been inaccurate. Additionally, and more significantly, the data collected for the user will not generally include external factors and activities that determine how users interact with each other and businesses. That is, although interactions outside the sphere of the business can affect how users will interact within the sphere of the business, the business will generally have no efficient way to capture this information. As a result, data typically collected by a single business will generally be insufficient to accurately reflect the tendencies and behaviors of users.

Accordingly, the various embodiments of the invention provide an ESN-based methodology for combining information regarding users from multiple sources and providing an accurate model for predict user behaviors and determining how to provide goods and services to user. Specifically, the methodology in accordance with the various embodiments involves collecting information regarding multiple users from multiple sources, discerning the ESNs formed by such users, and generating a model that for determining the transitions between the ESNs. The model can then be used to provide augmented information to a business regarding a user, indicating potential actions, factors, or other information to consider regarding a user in order to cause or attract the user towards certain activities.

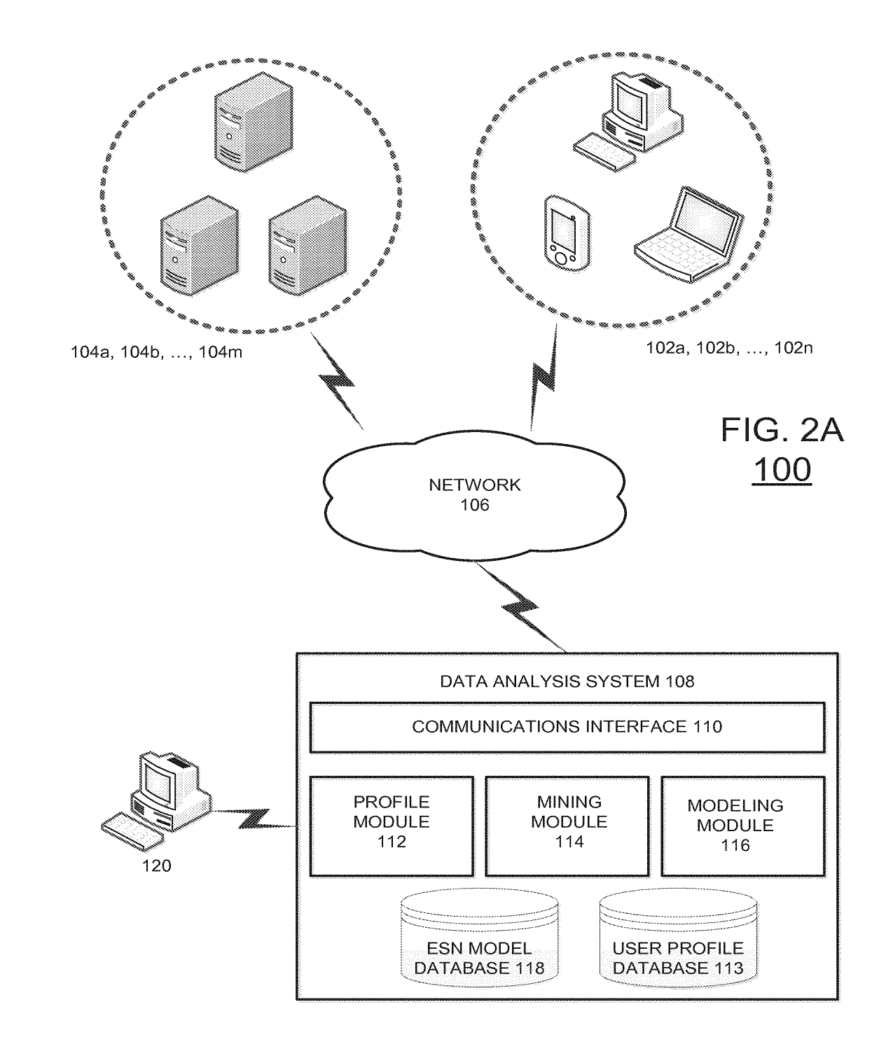

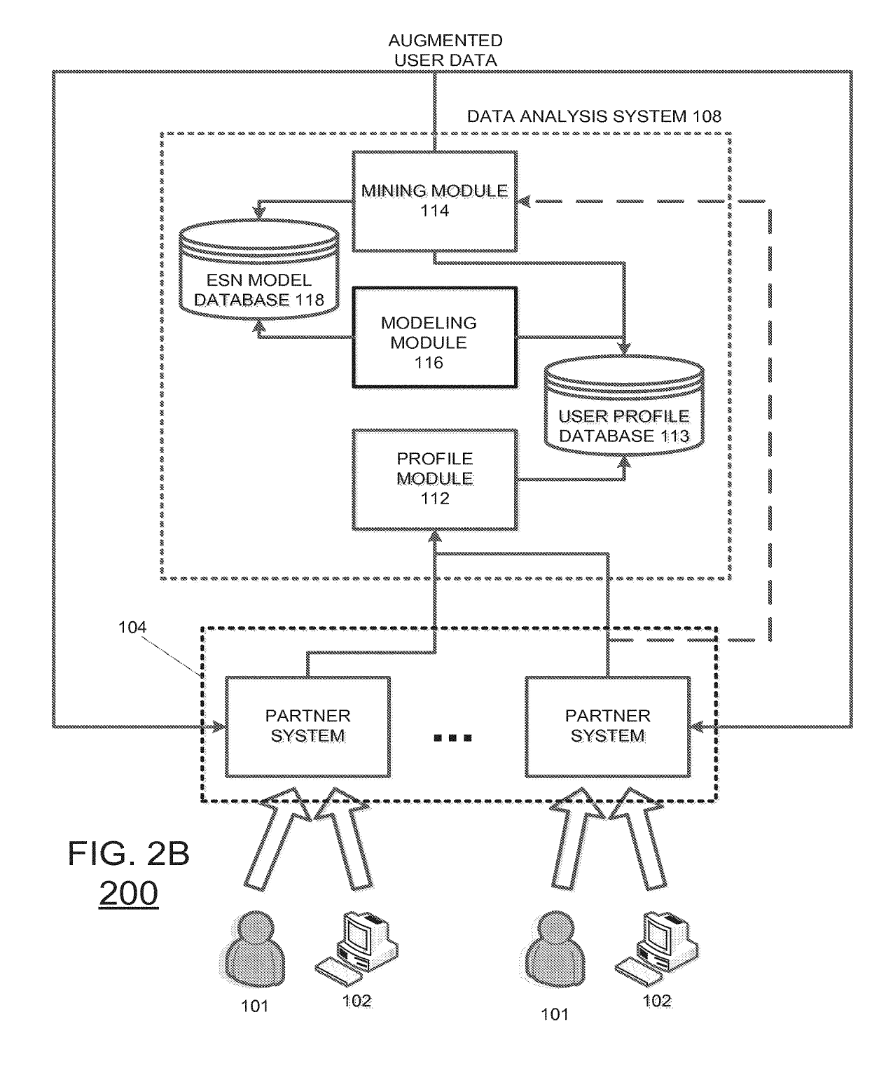

Prior to discussing the various details regarding the various embodiments, the disclosure first turns to FIG. 2A, which illustrates a configuration for an exemplary system 100, wherein electronic devices communicate via a network for purposes of exchanging content and other data. The system 100 can be configured for use on a network 106 as that illustrated in FIG. 2A. However, the present principles are applicable to a wide variety of network configurations that facilitate the intercommunication of electronic devices. For example, each of the components of system 100 in FIG. 2A can be implemented in a localized or distributed fashion in network 106.

As shown in FIG. 2A, the system 100 includes one or more user terminals 102a, 102b, . . . , 102n (collectively “102”) and one or more partner systems 104a, 104b, . . . , 104m (collectively “104”) communicatively coupled via network 106. The user terminals 102 and the partner systems 104 can be used to engage in conventional interactions, such as financial transactions, data collection activities, or providing goods, services, or information to users. Although each of user terminals 102 could be associated with a particular user or group thereof on an ongoing basis, the present disclosure also contemplates that the users may only be temporarily associated with one of user terminals 102. Thus, such a user terminal merely provides a point for a user (or his proxy) to input information. Any type of user terminal can be used, including, but not limited to computers, smartphones, tablet devices, automobile information systems, and the like.

In FIG. 2A, the user terminals 102 and the partner systems 104 are illustrated as being separate and distinct. However, the present disclosure contemplates that a partner system can incorporate or be directed coupled to a user terminal. Further, the present disclosure also contemplates that a user terminal can be under the control of a user or under the control of a particular partner system. For ease of illustration, the configuration and operation of system 100 will be primarily described with respect to transactions between users accessing user terminals 102 and entities associated with the partner servers 104. However, the various embodiments are not limited in this regard and the present technology can be used with any type of transaction.

The system 100 also includes a data analysis system (DAS) 108 for collecting user information and for providing augmented information to partner systems 104 in order to more properly serve users. The DAS 108 can include a communications interface 110, a profile module 112, a user profile database 113, a mining module 114, a modeling module 116, and an ESN model database 118.

The communications interface 110 can be utilized by the DAS 108 to manage communications between partner systems 104 and the DAS 108. The profile module 112 can be utilized to collect and organize information received from partner systems in user profile database 113. The modeling module 116 can be used by DAS 108 to generate, based on information from user profile database 113 or elsewhere, one or more ESN models that describe ESNs and their associated transitions. These models can be stored in ESN model database 118. Additionally, the DAS 108 can be associated with an administrative device 120. The administrative device 120 can be directly coupled to DAS 108, as shown in FIG. 2A, but can also be coupled via network 106. Further, the administrative device 120 could be embodied in any of user terminals 102 or any of partner systems 104.

Although DAS 108 is illustrated in FIG. 2A using a specific architecture, this is solely for illustrative purposes and the various embodiments are not limited in this regard. For example, DAS 108 is illustrated in FIG. 2A as a single, self-contained system coupled to network 106. However, in the various embodiments the DAS 108 can alternatively be implemented in a distributed fashion over network 106. Further, the present disclosure contemplates that DAS 108 can be arranged in a variety of ways. For example, although DAS 108 is described in terms of specific elements with specific functionality, the functionality of two or more of these elements of DAS 108 can be combined into a single element. Alternatively, the functionality of any one element of DAS 108 can be divided among two or more elements.

Now turning to the operation of DAS 108, DAS 108 can be utilized to perform at least two basic tasks. First, DAS 108 can operate in concert with partner systems 104 to deliver augmented user information to the partner systems 104 based on ESN model. Second, DAS 108 can generate models that can be utilized to generate the ESN models for generating the augmented user information.

Turning first to the generation of the ESN model, the basic process is illustrated with respect to FIG. 2B. FIG. 2B is a logical diagram showing how data flows in system 100 shown in FIG. 2A. The data flow begins with users 101 (or their proxies) delivering data to the partner systems 104. That is, users 101 can provide data to partner systems 104 either directly, via one of user terminal 102 in communication with partner systems 104, or even via a third party (not shown) in communication with partner system 104. As previously noted, this data would generally specific to the interaction between users 101 and a particular one of the partner systems 104.

The partner systems 104 can then forward this user data to DAS 108. At DAS 108, this user data gets routed to profile module 112. The profile module 112 can then aggregate and organize this data so as to create a composite profile of the users based on the data from the various sources. It should be noted that in most cases, multiple ones of partner system 104 will provide profile module 112 with user data associated with the same user. This data can be stored, as described above, in user profile database 113.

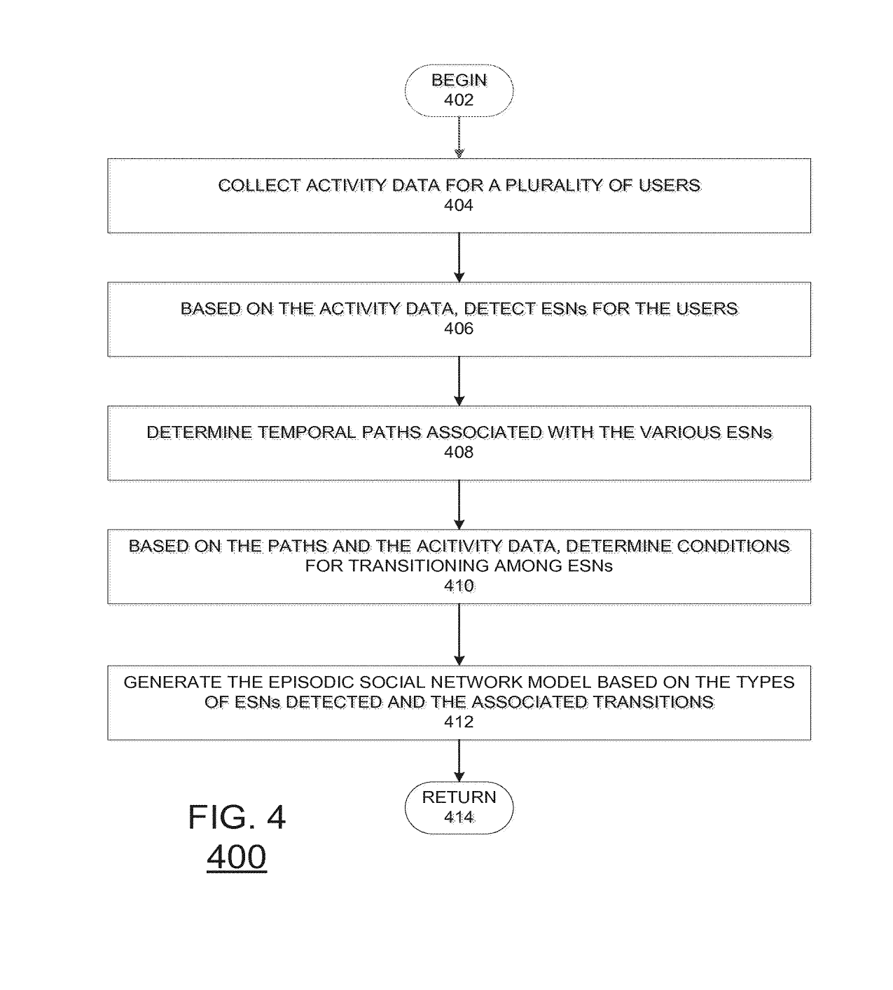

The aggregated and organized data in profile database 113 can then be accessed by modeling module 116. In particular, the data for multiple users 101 is analyzed to identify various ESNs associated with the user's activities and to identify any conditions or factors associated with users transitioning among these ESNs. Based on the ESNs detected from the aggregate user data and the transitions associated with the ESNs, a model can be generated that describes, based on a current user information, a current ESN for the user or a history of ESNs associated with the user (which includes a current ESN), future ESNs for the user, and conditions and factors that would cause users to transition to particular ones of the future ESNs. This modeling process will be described below in greater detail with respect to FIG. 4.

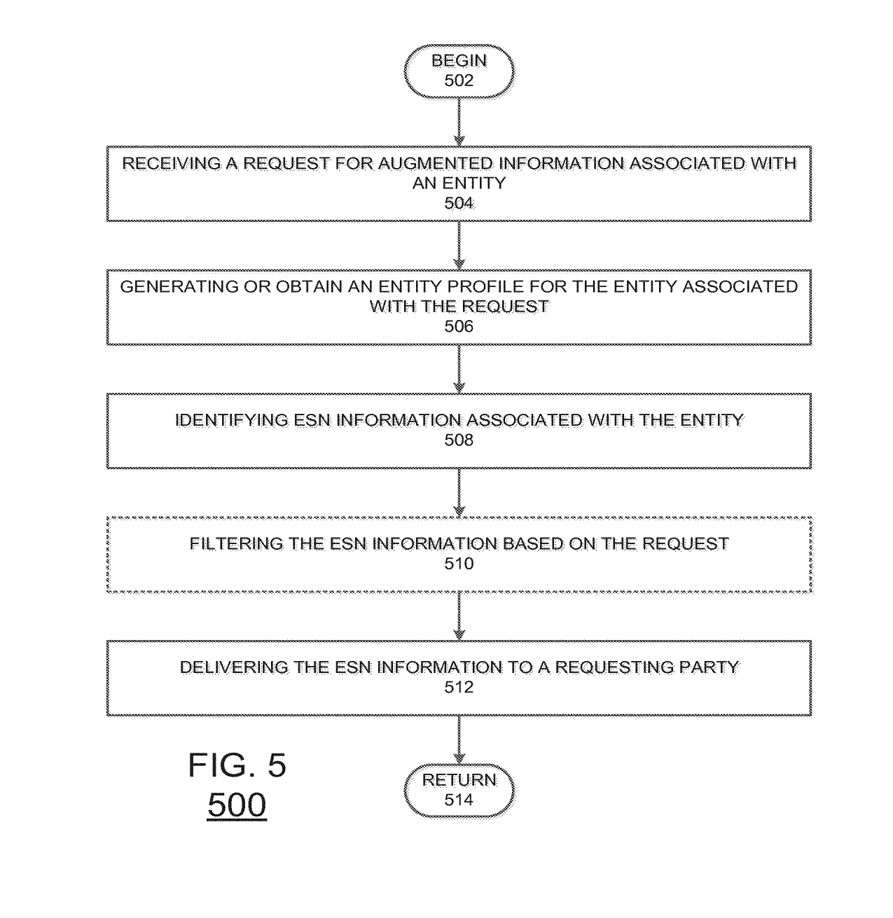

Now turning to the generation of the augmented user information, this process begins with a request at DAS 108, associated with one of partner systems 104, for augmented information regarding one or more users. At DAS 108, the request can be forwarded to mining module 114 to generate the augmented user information. In particular, the mining module accesses the data for the user in user profile database 113 and evaluates it using the ESN model in ESN model database 118. Specifically, the mining module 114 can utilize the user profile information to determine the ESN the user is currently associated with (or a history of ESNs for the user) and the future ESNs for the user. This information can then be utilized to generate the augmented user information for the one of partner system 104 associated with the request. In some cases, the augmented user information can also specify what types of conditions are required for transitioning from the current ESN to the future ESNs. Optionally, the augmented user information can be tailored for the particular one of partner systems 104 associated with the request. Further, the augmented user data can also include the ESN model created, or at least the portions pertinent to a particular user. These various process will be described below in greater detail with respect to FIG. 5.

The augmented user information can be used at the partner systems in a variety of ways. As noted above, a partner system can received several types of data. These can include information regarding a current ESN associated with a user and information regarding the next ESNs available for a user. Optionally, this information can be conveyed in the form of delivering not only the current ESN information for the user, but also at least part of the model generated at data analysis system 108. For example, any portions of the model developed at data analysis system 108, associated with a particular user currently interacting or otherwise of interest to a one of partner systems 104, can be delivered to the one of partner systems 104. Thus, using the augmented user information, including current information and model information, the partner system 104 can generate guidance for the user or conditions for the user to take specific actions.

More importantly, the partner system can use the model information to forecast potential actions and results involving the user, the partner system 104 can generate the guidance and conditions that is biased with respect to the partner system 104. Specifically, the partner system 104 can utilize the augmented user information to steer at user towards involvement in ESNs preferred by the partner system 104. Such a processing can involve the partner system performing a ranking of ESNs available for the user and their after biasing guidance and conditions to lead the user to the higher ranked ones of the ESNs.

This can be done in a direct fashion, by providing guidance or contriving conditions that cause the user to take specific actions such that the user to immediately transitions to a desired ESN. Alternatively, this can be done in an indirect fashion. Specifically, the partner system 104 can provide guidance or contrive conditions that lead users down a path of various ESNs that eventually result in the user reaching the ESN desired by the partner system 104. In some cases, the guidance and contriving of conditions can be relatively minor such that the user is unaware of the goals of the partner system 104. For example, the partner system 104 can guide users down a path of ESNs that seem, at least to the user, unrelated to the partner system 104 or its goals. Further, the guidance and conditions for guiding the users down such a path of ESNs can also appear to the user to be unrelated to the partner system 104 or its goals.

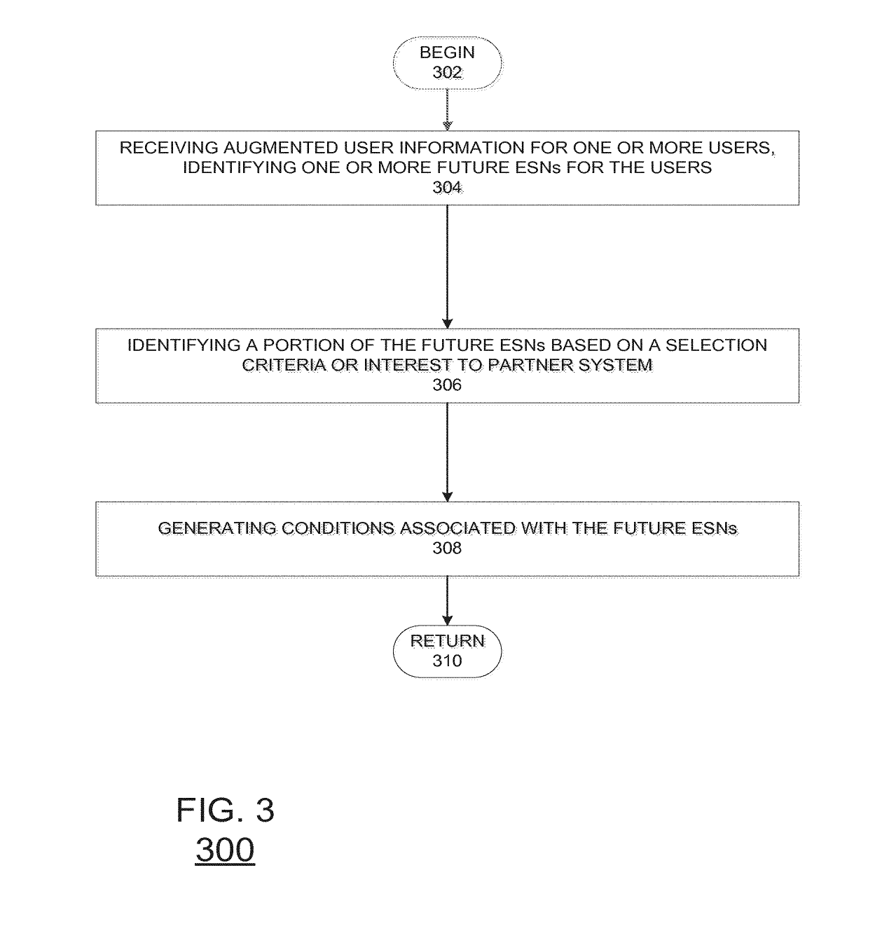

A basic flow for such guidance is shown in FIG. 3. FIG. 3 is a flowchart of steps in an exemplary method 300 for using augmented user information at a partner system in accordance with the various embodiments. The method 300 begins at step 302 and proceeds to step 304. At step 304, augmented user information for users of interest to the partner system can be received. The augmented user information data can include current ESN information for the user, future ESNs for the user, and conditions required for reaching such future ESNs. Additionally, the augmented user information can also include any ESN models, as described below in greater detail, generated for the user or a group of users.

The method can then proceed to step 306. At step 306, a portion of the ESNs can be selected by the partner system. In particular, these can be the ESNs of particular interest to the partner system, such as those resulting in a financial advantage or benefit to the partner system or an affiliate of the partner system. However, ESNs providing other types of advantages or benefits can also be selected. At step 306, selection criteria can be provided to allow the partner system to make this determination. This selection criteria can be predefined. Additionally, the selection criteria can also consider benefits or advantages to the user. Therefore, ESNs can be selected that are advantageous to the partner system, the user, or both. Further, the present disclosure contemplates selecting all ESNs from the augmented user information, provided that they have some association with the user of interest.

Finally, at step 310, conditions can be generated for the identified future ESNs. This can involve providing at least one of guidance, an incentive, or a recommendation to the at least one entity for causing the future conditions to occur. In the various embodiments, the partner system can have a redirection criteria for determining which transition to associate with guidance, an incentive, or a recommendation or even for determining which transitions to favor. For example, the redirection criteria can be a ranking criteria. In such embodiments, the selected ESNs can be ranked according to some ranking criteria. The ranking criteria can be based on factors of importance to the partner system, its affiliates, the user, or even society at large. Thus, the guidance, the incentive, or the recommendation for each of the selected ESNs can be biased to favor higher ranking ones of the selected ESNs. Other types of redirection criteria, other than ranking criteria, can also be provided. The present disclosure also contemplates that the guidance, the incentive, or the recommendation is not limited to the users of interest. Rather, in some embodiments, these can be provided to other users, entities, or groups that interact with the user of interest. Once the conditions are generated at step 310, the method can then end at step 312.

The present disclosure contemplates that there may be multiple paths associated with reaching an ESN. Accordingly, a partner system with knowledge of such multiple paths, can utilize different strategies. In some embodiments, the partner system may only be concerned with the user reaching a target ESN. Accordingly, as long as a transition from and ESN is associated with a path of ESNs and transitions leading to a target ESN, incentives or recommendations of such paths can be provided. However, the present disclosure contemplates that the timing of guidance, incentives, and recommendation can attract or detract a user from a particular target ESN. For example, if a target ESN can be reached from a starting ESN via multiple paths, a particular recommendation or incentive at one point along a first path may have a completely different effect than the same recommendation or incentive at a different point along the same path. Further, some types of guidance, recommendations, and incentive may lead users to the target ESN, but not as quickly as the partner system would prefer. Accordingly, in some embodiments, the partner systems can select incentives, guidance, and recommendations in order to direct a user to a target ESN in the most efficient manner possible by providing some type of efficiency criteria for favoring particular transitions. In one example, such an efficiency criteria can be used by the partner system to cause it to determine and select the quickest paths that will lead the user to the target ESN. Thereafter, the partner system would provide incentives and recommendations that are biased to cause the user to traverse the quickest path. In another example, such an efficiency criteria can be used by the partner system to cause it to determine that particular paths pose the lowest risk of the user not reaching the target ESN than other paths. In these cases, the partner system can again provide incentives and recommendations that are biased for these more efficient paths. In still another example, a partner system may have multiple target ESNs. Accordingly, the partner system can again provide incentives and recommendations that are biased to direct the user to as many of these target ESNs as possible.

Some exemplary use domains for the methodology described above are presented below. A first use domain for the various embodiments is to use augmented user data at the partner systems to generate data that provides or leads guidance for individuals. Specific examples include, but are not limited to, academics, sports, hobbies, and workforce training, as discussed below.

Academics. Students in the early years of education may be undecided as to an eventual course or field of study. Further, perquisites and/or graduation requirements may change over time. A conventional partner system might maintain a record of milestones or decision points and prompt the student at predefined intervals to make changes to comply with current requirements in a field of study. Such a system might even provide students with information regarding other fields of study and how completed classwork would apply to completion of a degree in such other fields of study. The various embodiments could be used to build the existing functionality of such partner systems.

That is, in addition to providing the foregoing information to student, a partner system in accordance with the various embodiments can be used to influence decisions regarding coursework and field of study based on information other information associated with the student, but not necessarily related to coursework records of the student.

For example, the student may not be initially interested in a particular field of study, such as medicine or engineering, but information stored in other systems may indicate that the student has an aptitude or interest in such a field of study. For example, information associated with social networks, non-coursework activities, and other information may indicate that a student is associated with ESNs associated with other persons with an express aptitude or interest in a field of study. Thus, the partner system, based on augmented user data, can make an express recommendation regarding field of study or coursework. Alternatively, the partner system can offer the student invitations to join or interact with groups with an established affinity. For example, the system can: introduce the student to others of like aptitude or interest in a particular field, offer incentives (economic or otherwise) to interact and join organizations associated with the particular field, recommend lectures, presentations, or other activities associated with the particular field, or recommend elective courses in the particular field.

Although such systems can be provided for the benefit of the student, an academic institution can take advantage of the various embodiments as well. For example, the various embodiments can be utilized to direct students to less popular classes or fields of study by incentivizing such changes. Similarly, the various embodiments can be used to redirect students away from crowded yet popular classes or help students accelerate to graduation. In such cases, the incentives can include offering the alternate course(s) at a discount cost, offering a waiver of specific graduation requirements in exchange for selection of the alternate course. In still another example, incentives can be provided to third parties. For example, a group can be recommended to seek out a particular student and invite him to join their group. This recommendation can include some type of incentive to the group so that they are inclined to offer the invitation. Such an incentive can be, for example, in the form of monies, goods, services, facilities, etc. However, the various embodiments are not limited to any particular type of incentive.

Moreover, when there is a greater need in society for skills in a particular field, the partner system can be configured or adapted to account for such needs. Specifically, the incentives, invitations, or recommendations described above can be configured with a preference for the particular field. In some cases, the incentives, invitations, or recommendations can be express and can be configured to persuade the student that he or she should shift to particular field of study. Alternatively or in combination with such express guidance, subconscious or indirect guidance can be provided. Specifically, the student can be provided with guidance that is likely to lead the student to participate in ESNs that are known to result in students selecting a particular field of study. It should be noted that the guidance can be configured such that the student is led through multiple ESNs before reaching a desired result.

Sports and Hobbies. Individuals who like or are proficient in a first sport, may potentially be interested in cross training for a second sport. Thus, the partner systems can be configured, based on the augmented user information, to invite or induce the user to train for the second sport or for a third sport that leads to the first sport. For example, an Olympic class weightlifter could probably train and be successful in shot-put. Thus, similar to the student example above, the partner system provides the weightlifter with incentives, invitations, and recommendations to lead him direct to the second sport or indirectly via the third sport. Similarly, individuals can be introduced to hobbies or other activities based on their current hobbies, interests, and other information. Alternatively, groups can be incentivized by a partner system to reach out to the individual in return for an incentive.

Workforce Training. Individuals with certain skill sets, may potentially be interested in learning new, but related, skill sets in contemplation of pursuing a promotion within a company or even in contemplation of pursuing a position elsewhere. Thus, the various embodiments can be utilized by a language learning company to invite or induce the individual to learn a new skills set that could be applied to a new position. For example, a French translation could probably train and be successful in learning another Latin-based language and thus learn to translate a second language. Thus, similar to the student example above, the worker can be provided incentives, invitations, and recommendations by a language learning company or a related entity to lead him directly or indirectly to learning this new language. Similarly, any other company or entity providing courses for teaching new workforce skills can use the augmented user information to target individuals.

Although companies that teach new workforce skills can take advantage of the augmented user information, the companies that ultimately hire individuals can also use the augmented user information to ensure an adequate pool of applicants will be available. For example, a company may forecast a need for workers trained for a particular skill set (e.g., French translation and accounting) and the pool of available applicants may be limited or projected to be limited. However, companies may also recognize that individuals with translation skills associated with other Latin-derived languages and having accounting and other skills required by the company can be trained to translate French. As such, the company, working separately or in conjunction with the language learning company, can operate as a partner system that causes that potential workers receive inducements, invitations, and recommendations. Accordingly, based on a projected response to such guidance, the company can be assured that a sufficient number of workers with desirable skill sets are available when the company is ready to hire. As with the student example above, this can also involve the individual being led through multiple ESNs before reaching a desired result.

The various examples above describe guiding a single user to a particular ESN of interest to the partner system. However, the augmented user data can also be used to bring individuals together who normally would not have associations. More specifically, these individuals can be brought together to provide an association of particular interest to the partner system. For example, companies offering information database services in a multi-tier data base system (e.g., LEXISNEXIS managed by the LexisNexis Group of Dayton, Ohio) grow their business by having customers purchase access to higher level services. However, customers would need a reason to purchase such higher level services. Using the augmented user data, the company can provide such a reason. For example, the augmented user data can be utilized to guide separate customers to an ESN in which they interact to the extent that one or both of the customer will need to purchase the additional level of service. In other words, the affinity of the separate customers can be aligned.

In one specific example, the styling of cars may follow that of performance aircraft as it has in the past (example automotive tail fins resembling the vertical stabilizer of aircraft) because there is a common interest in performance. Thus, an aircraft design group can be led to interact with a car design group. As a result, the car design group is likely to have greater interest in aircraft design and vice versa. Accordingly such a scenario would provide such customers a reason to extend their levels of service. Similarly, this methodology can be applied in a number of other areas: cameras, personal electronics, sporting equipment, and even women's fashions. As such, affinity groups of designers, retail buyers, style consultants, magazines, and other influencers of style can be formed such that there is a deliberate cross pollination of attitudes and preferences.

A partner system can also cause an alignment of affinity to be seeded by guiding or inviting users to specific conferences and professional societies, with a goal that their participation leads to a membership in an affinity group in alignment with the goals of the partner system. The partner system can then require a paid subscription for membership. The affinity group may be national, or corporate, or geographic with the goal of attracting the greatest number of potential customers for products of this coordinated design strategy.

Such an approach can be utilized to align users into a same affinity group with respect to politics, religion, and other issues. That is, the partner systems can be configured to coordinate incremental steps through ESNs as part of long term planning toward increasing membership, or altering aggregate wisdom and attitudes of a group at large based on planned migration of the ESN through incentives. The coordination can be based on the augmented user data received for the different users.

For example, there may be a partner system interested in the goal of formally adding a 10^{th} inning to the game. Using augmented user information, the partner system can coordinate successive incentivized migrations to cause the merging of users with other users or groups that believe 9 to be less desirable than 10. Thus, this can eventually lead to social pressures within the groups and permit the 10^{th} inning concept to be discussed. Eventually, by managing peer pressure toward a preference for 10 or anything, a majority position is created.

Life planning. Previous scenarios have focused on the partner systems providing “involuntary” covert group guidance. However, some individuals may subscribe to voluntary life planning where initially they state particular goals and they are shaped into training, careers, affinity associations, where pivotal decision points are biased on transition from one stage ESN to another. For example, if a goal is set to live comfortably, but a high level of risk is acceptable if enough repeat opportunities increase the likelihood of the outcome. A partner system can utilize the user augmented information to control a succession of ESNs, where at each decision point, some bias is given to the individual along a path.

In a similar example, some groups operate outside of society to its detriment, such as organized crime and terror groups. Initially, these groups may form by their own affinity, but by providing guidance at specific steps after formation, it may be possible to effect disbandment or reformation. Alternatively, it may be possible may allow influential individuals to join and or cause influential events to occur that enhance the desired management of the group. Where opposing influence within the group might derail the desired direction, surveillance and removal of specific individuals from an ESN could be effected. These specific ESNs might well precede formation of an affinity group that eventually achieves the goal.

For example, a terror group may be absent a skill in organic chemistry and an individual trusted by the group is given education by scholarship in that area. When such individuals are identifiable, the augmented user data can be utilized in several ways. First, the trusted individual trained in organic chemistry can be made unavailable to the group by arranged circumstance. Specifically, the training efforts of the trusted individual can be thwarted or the trusted individual can be redirected to ESNs that make it less likely the trusted individual will support the group's efforts. Additionally, with augmented user information regarding the group, the group can be steered to a different individual, one that is covertly operating against the goals of the group. When then next ESN is formed, it inherits the covert individual. However, it may take several ESNs from in parallel or sequentially to internalize the covert individual and lead toward an ESN where sufficient trust is placed in the covert individual by the group. Most importantly, this process can be facilitate by the various embodiment since the modeling of ESNs and transitions allows these associations to occur via seemingly inconsequential events that do not raise suspicions of the group, but are instigated at pivotal milestones in the transition from one ESN to another.

Life planning can also involve disease care and management. In practice, a succession of health care teams is typically utilized to manage the health of an individual through his life time. Each of these teams and the interaction with the individual can be considered to define at least one ESN. However, one of the difficulties in maintaining a healthy lifestyle is patient compliance. Even when peer pressure is applied or a reward is offered for healthy lifestyle choices, it is often too easy for the patient deviating from preferred behaviors. The augmented user profiles can be used to at least partially manage such behaviors.

For example, an individual with emerging diabetes is normally recommended to make lifestyle choices involving nutrition and fitness. However, getting the patient to comply with such choices can be difficult. Accordingly, the augmented user information can be used to steer the patient. Specifically, the patient can be directed to ESNs resulting in associations with other individuals, where such individuals are selected based on the augmented user information. These ESNs can be selected as including individuals likely to become peers of the patient and thus influence nutrition or fitness choices. Thus, the patient's interactions with these peers may alter lifestyle, specifically eating habits and food choices through group peer pressure. In time, via additional redirection to such peers, the patient's attitudes may permanently change and make the progression of the disease more manageable.

Later ESNs may deal with management through drug therapy and management of ancillary chronic problems such as reduction of eyesight and neuropathy. The plan for the patient can then be adjusted over time to similarly promote healthy lifestyle choices and pro-active management of the disease. Thus, the plain for the patient can be designed such that the patient proceeds to ESNs that prevent or at least postpone the least manageable and dangerous side effects. At each point, there can be fees, referrals, services that generate incentives for not only the patient, but also for peers and health care personnel.

Customer planning. Consider a casino. To optimize revenue, over time, players are encouraged to move to more profitable games and wealthy players are encouraged to move to even higher stakes games. To do this, some players would be given strategic encouragement at specific milestones where they would move from one ESN to the next. Specifically, encouragement to move to specific ESNs preferred by the Casino. To accomplish this, salient information from an individual's cumulative life experience, such as a personality profile, would be mined from various partner systems and analyzed, as described below, to determine what encouragement to provide to bias each transition. A person's optimism or feeling of luck would be elevated by winning initially with frequency of reward diminished over time, but held at a threshold satisfactory to maintain their interest.

Further, the individual might be introduced to other individuals who have recently won, to re-enforce greater feeling of potential favorable outcomes. Negative reinforcement, such as news of an individual's losses elsewhere or by individuals with whom they might identify might be withheld until after a milestone decision has been made. In each new game ESN, odds, or rules could potentially be adjusted initially to allow for more success as well. A player would always be left with sufficient funds to restore their level of wealth. While this process might be illegal in many jurisdictions—elsewhere it could become optimally effective with heuristic tuning of timing or reward and penalty.

Self help and focus—Various organizations offer training for organizing one's life toward selected goals, such that focus is maintained, limiting practices are reduced. A programmed plan for this education and personality adjustment could be defined using the augmented user information, similar to the healthcare example above. Initially, the individual can be steered to ESNs that incorporate identification of limiting beliefs, with successive ESNs selected to create confidence, become inner directed, learn leadership and network formation. At each point, there can be fees, referrals, services that generate incentives for not only the individual being trained by the organization, but the ESNs and transitions can also be selected that are financially advantageous to the organization or its affiliates.

The examples above are provided merely to illustrate some basic methods for using the augmented user information. The present disclosure contemplates that augmented user information can be used in any other scenarios where redirection of a user or entity desired by partner system, and specifically redirection of the user or entity to ESNs that provide some type of advantage to the partner system or affiliated partner systems.

Now turning to FIG. 4, there is shown a flow chart of steps in an exemplary method 400 for generating an ESN model in accordance with an embodiment of the invention. The method begins at step 402 and continues on to step 404. At step 404, activity data is collected for a plurality of users. That is, gathering and organizing the data obtained from partner systems 104. As noted above, this can include activity data regarding direct interactions between users and the partner systems 104, observations regarding user activities collected by entities associated with the partner system 104, or any other type of data collected by the entities regarding the users. In the exemplary data flow of FIG. 3, this process is illustrated by the data from as the partner systems 104 to the DAS 108.

Although the preceding description implies some action to forward this data must occur at the partner systems 104, the various embodiments are not limited in this regard. Rather, the present disclosure also contemplates that the profile module can be configured to cause the DAS 108 to automatically retrieve user data from the partner systems. This can occur on a scheduled or random basis. For example, the DAS 108 can be configured to automatically retrieve data in response to a request or retrieve data when a workload at the DAS 108 is low or a communications link between the DAS 108 and one or partner systems 104 has a high capacity. Further, the DAS 108 need not obtain user data from each of partner systems 104 in the same manner. Rather, the DAS 108 can access user data at each of the partner systems in a different way. For example, depending on the workload and/or communications link quality associated with each of the partner systems 104 can dictate how the DAS 108 retrieves user data.

Similarly, the partner systems 104 can also be configured to deliver user data on a regular or random basis, relying on a similar set of criteria for determining when to deliver user data. Further, in some instances, a combination of partner system-initiated and DAS-initiated data retrieval processes can be used.

In some embodiments, the data collection can occur as needed, such as when new data is collected. Further, the data collection can occur whenever a new request for augmented user data is received. Also, the amount of data collected can also vary. That is, the data collected can be limited to solely new data or can include new and old data. The present disclosure also contemplates that any other methods for collecting data from remote systems can also be used in the various embodiments.

The activity data collected at step 404 can include temporal data and non-temporal data associated with activities involving the users. The temporal data can identify the date and time associated with a particular activity. The non-temporal data can identify other aspects of the activity and the user. For example, the non-temporal data can include activity detail data, geolocation data for the activity, and demographic or other identifying data associated with the user. As previously noted, the geolocation data can specify physical or virtual locations. However, the various embodiments are not limited in this regard and any other type of non-temporal data can be included in the non-temporal activity data.

The present disclosure further contemplates that step 404 would include a step of organizing the collected data. That is, the data can be categorized or classified according to any criteria to provide the data set needed for generating the ESN model. This can optionally include removing any irrelevant data from the activity data being collected or not performing categorizing or classifying of such information. In the various embodiments, the organizing of the collected data can be based on pre-defined criteria supplied via the administrative device 120 or other similar interface. Alternatively, the criteria can be defined based on the partner systems 104. That is, an entity associated with each of partner systems 104 can define the categorization and classification needed for ESN types of interest. Alternatively, profile module 112 can be configured to analyze the data obtained from partner systems 104 and automatically generate the criteria for organizing the data.

Once the user data has been collected at step 404, the data can be analyzed at step 406 to identify the ESNs associated with the user data. In some embodiments, the criteria for analyzing the user data and discerning the ESNs can be predefined. For example, pre-defined criteria can be provided that specifies identifying ESNs based on specific temporal and non-temporal boundaries. As with the organizing, the criteria for discerning ESNs can be pre-defined via the administrative device 120, at the partner systems 104, or based on a combination of both.

The present disclosure also contemplates that in some embodiments, automatic methods can be utilized for identifying ESNs that do not require selecting precise temporal and non-temporal boundaries. For example, present disclosure contemplates that techniques such as cluster analysis, a cross-classification analysis, or choice-based analysis can be used. However, the various embodiments are not limited in this regard and any other analysis types can be used to discern ESNs based on the aggregate user data. Further, the various embodiments can utilize a combination of pre-defined criteria and automatic methods for discerning ESNs.

The present disclosure also contemplates that the analysis can be used to define ESNs indifferent ways and according to different criteria. As a result, an activity associated with a user can belong to multiple ESNs. For example, the identified ESNs can include ESNs that are nested, partially overlapping, or both.

After the ESNs are identified at step 406, temporal paths among the identified ESNs can be determined at step 408. That is, a path can be identified consisting of a temporal sequence of ESNs associated with the same or substantially the same set of users. For example, if there is a temporal sequence of ESNs associated with the same set of users, a path would be defined. In another example if there is a temporal sequence of ESN associated with at least a minimum number of users associated with some criteria (i.e., a quorum), a path can also be defined. It should be understood that the present disclosure contemplate that a quorum, as used herein, refers to any number of users from a group, not just a majority of users. Thus a quorum could include a number of users that is less than a majority of the users in a group.

The present disclosure also contemplates that some ESNs can be associated with one or more paths. In the case of nested or overlapping ESNs, these ESNs can be associated with the same or different paths.

Once the temporal paths are identified at step 410, the conditions for transitioning between the ESNs can be determined. In particular, the activity data associated with the ESNs in a particular path can be analyzed to determine common conditions, factors, or other influences associated with users that transition from one particular ESN to another. For example if a portion of the users in one ESN transitioned to a first ESN and the other portion of the users in the one ESN transitioned to a second, different ESN, the conditions, factors, or influences resulting in this divergence among users can be estimated. In another example, if a portion of the users in a first ESN transitioned to a second ESN and now further activity was observed for the other portion of the users, the conditions, factors, or influences resulting in this divergence among users can also be estimated. Similarly, other differences in paths can be analyzed to determine factors, conditions, and influences leading users among the different ESNs.

Once the transitions among the ESNs have been characterized at step 410, the ESN model can be generated at step 412. As described above, one aspect of the model can be used to provide identification of an ESN (or history thereof) for a user. The model can be constructed to address this aspect by identifying and characterizing the different types of ESNs discerned at step 406 and generating criteria for classifying user activities into one or more of these ESN types. This aspect of the model is then further configured to apply a time criteria to divide these activities based on time of occurrence. Thus, the model provides a time and type classification to determine a current ESN (or history thereof) for a user based on a user profile.

Another aspect of the model is that it can also be used to identify future ESNs for the user and factors or conditions associated with transitioning to such future ESNs. In particular, the temporal paths determined at step 408 can be used with each of the types of ESNs identified to further identify the types of ESNs that would follow. Thus the model can specify types of future ESNs associated with a particular ESN type. Additionally, the temporal paths can also be used to identify the conditions, factors, and influences associated transitions between types of ESNs. Thus, the model further provides a future ESN prediction and transition information based on the user profile. After the ESN model is generated, the method 400 can then proceed to step 414 and resume previous processing, including, but not limited to, repeating method 400.

Turning now to FIG. 5, there is shown a flowchart of steps in an exemplary method 500 for providing augmented user information. The method 500 can begin at step 502 and continue on to step 504. At step 504, a request is received for augmented information for an entity. As used herein, the term “entity” refers to one or more users, an organization or business, or any other grouping of persons, assets, and the like.

In the various embodiments, the request can be generated in several ways. For example, in some embodiments an express request can be provided to DAS 108. That is, one of partner systems 104 can forward a message to DAS 108 for augmented user information regarding one or more user. However, in other embodiments, the request can be implied. That is, the request is generated based on some other action at the user terminals 102, the partner systems 104, or the DAS 108. For example, a request can be implied whenever new user data is transmitted between partner system 104 and DAS 108. In one particular example, the request for one of partner systems 104 can be generated responsive to user data provided by the one of partner systems 104. In another particular example, the request for one of partner systems 104 can be generated responsive to user data provided by a different one of partner systems 104. In the case of such implied requests, threshold criteria can also be specified for the generating of the request. For example, the criteria can specify that a minimum of amount of changes in the user data is required before a request is triggered. A similar criterion can be utilized in the case where the DAS 108 automatically pulls data from the partner systems 104. However, the various embodiments are not limited to any particular method and any other methods for automatically generating such requests can also be used without limitation.

After the request is received at DAS 108, an entity profile can be generated or obtained for the entity associated with the request at step 506. Step 506 can involve accessing the user profile database 113 to retrieve user information associated with the entity and generating a profile for this entity. In some cases, the user data may already be assembled in a user profile that can be directly used. However, in cases where an entity consists of two or more users, this can also involve collecting information regarding the various users associated with the entity and aggregating the information to form a composite user profile for the entity. The method can then proceed to step 508.

At step 508, the activity data for the entity and the ESN model can be utilized to identify ESN information for the entity. In particular, the identified ESN information can include identification of a current ESN type (or history of ESNs), future ESNs for the entity, and the conditions associated with transitioning to the future ESNs. In some embodiments, the associated ESN model can be identified for delivery the partner system. The present disclosure contemplates that in some instances, the analysis of the activity data for the entity can result in the identification of two or more current ESNs for the entity. In such cases, a confidence score can be calculated for each of the ESN types. Such a calculation can be performed in various ways. For example, the confidence scores can be computed of a comparison of the activity data to the characteristics of an ESN type. Accordingly, the closer the comparison results are, the higher the confidence score will be. Any other means of computing confidence scores can also be used without limitation. The present disclosure also contemplates that such confidence scores can also be utilized to limit the results. For example, only results that meet a certain criteria are selected. This can be applied not only to selection of current ESN types, but also to future ESN types.

Optionally, a step 510, a filtering criteria can be utilized to limit the ESN information to include in the augmented user information. That is, an entity associated with a partner system 104 may only be interested in the occurrence of particular types of ESNs. Further, an entity associated with a partner system 104 may only have control over certain type of conditions or factors. In either case, some of the ESN information generated at step 508 may be of little or no use at the partner system. Accordingly, a filtering process can be utilized to limit the ESN information to only that information of interest to a one of partner systems 104 that is to receive the augmented user information.

The filtering at step 510 can also be used to provide different levels of service to partner systems 104. For example, the degree of the relationship between different entities associated with the partner systems 104 and the entity associated with DAS 108 can also vary. Thus, the filtering can be used to censor the data such that those of partner systems 104 associated with “preferred” entities receive a greater amount of augmented user information than other ones of partner systems. This can be accomplished by limiting the amount of data or details associated with a particular user. Alternative, this can also be accomplished by providing summary or more generic information for an entity, rather than the detailed information for an entity.

Following step 508 (and optionally step 510), the ESN information can be delivered at step 512 to at least one of the partner systems 104. In some embodiments, the ESN information for an entity can be delivered specifically to a requesting one of partner systems 104. In other embodiments, the DAS 108 can determine any of partner systems 104 associated with the entity associated with the ESN information and deliver the ESN information thereto. Once the ESN information is delivered at step 512, the method 500 can proceed to step 514 and resume previous process, including repeating method 500 for other requests.

Once the ESN information is received at the partner systems 104, the entities associated with the partner systems can utilized the ESN information to contrive conditions that result in users engaging in certain activities. That is, causing users to transition to one or more particular ESNs. For example, having knowledge of the current ESN for a user, future ESNs for a user, the conditions and factors associating the current ESNs to the future ESNs, and optionally the ESN model, the entity associated with a partner system can cause the conditions or factors associated with a desired one of the future ESNs to occur. The present disclosure contemplates that this can require contriving conditions for a user to transition between several ESNs. In a practical scenario, this allows businesses to determine the conditions necessary for the business to retain a new customer. Thus, the business can take the appropriate actions so to retain the new customer.

Another example where the concepts describe above can be utilized is the scenario of a cruise. A cruise is an activity that is finitely bounded by the confines of the ship, the length of the voyage, and the membership of the passengers and crew. Additionally, the cruise can also be bounded, to some extent, by the onshore support services that prepare the ship's facilities and ports of call. Thus, the cruise forms an ESN, as it is finite in space, time, membership and affinity of purpose. However, the cruise can also be considered a large, complex ESN that is an aggregation of multiple ESNs amongst the crew and passengers served by them. For example, the ship's manpower may be seen as participating in multiple ESNs that combine multiple services and specializations to create the entire cruise experience. The passengers may be assembled from multiple affinity groups and may or may not be segregated further by restrictions of access, such as regions of the ship designated for classes of service.

Within passengers, there are typically multiple groups. Here, by example, are some common membership groups. In order to optimize service delivery and satisfaction, (and thereby revenue), of critical importance is the understanding of what the various groups are and what leads (or leads away from particular interaction between them. For example, the groups on a cruise may be:

e. Passengers may wish to opt out of activities and remain indolent to rest.
f. Passengers who opt for multiple activities
g. Smokers
h. Non-Smokers
i. Mountain climbers
j. Scuba Divers
k. Dancers
l. Gamblers
m. Golfers
n. Baptist Fundamentalists

In some cases, the group classification itself defines the affinity for the members for determining the ESNs they belong to and based on the ESN modeling and ESN information generating described above, the conditions and factors for leading particular types of users to particular activities can be obtained. However, in some cases, there may be additional criteria to consider for purposes of determining ESNs and how to properly route users to ESNs. That is, in some cases it may be desirable to purposely separate specific types of users since their direct interaction may be undesirable at times or there may be issues with certain types of users engaging in certain type of activities. Further, there may be other knowledge associated with particular groups of users that redirection to particular activities would be more profitable. Examples are:

o. Smokers may be prime marketing targets for commodities within the ship and ports of call.
p. Smokers may not be safe candidates for Scuba.
q. Mountain climbers, scuba divers and dancers are less likely to be tolerant of smoker or be indolent themselves when on the ship.
r. Baptist fundamentalists might eschew and be offended by promotion of gambling, smoking and dancing, but may well be attracted to scuba diving or climbing activities.
s. Golfers may not be interested in particular beginner-level golf activities.

From the cruise operator's perspective, this data for classifying passengers can be acquired using:

t. Passive collection—Observational
u. Imported profile—Credit card history
v. User defined profile (Questionnaire)—Personality Test
w. Interactive SMS Friend (Eliza)—ongoing adaptive conversation
x. Random—“Surprise Me”—presentation and test (follow rules to avoid liability or risk of offense).
y. Interest Based (and based on previous affinities selected).

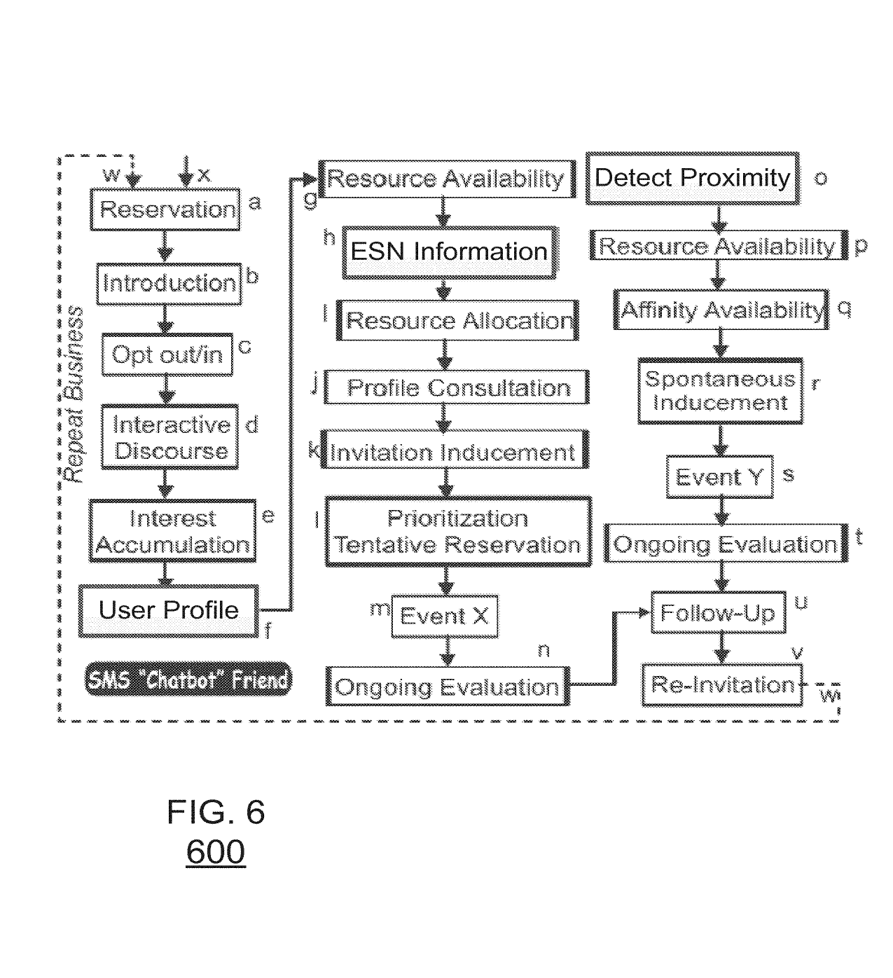

In some cases the data collection can be achieved via a conversational entity simulation that appears to have produced by a human. Such artificial intelligence engines have become quite sophisticated as real time “chatbots” adept at human verbal conversation via natural language processing and even incorporating visual “Avatar” representations of human intelligence. Although the chatbot can be provided via a user terminal in some embodiments, in other embodiments, SMS text messaging can be used for such interactions. An example flowchart of such a means for determining collecting data is shown in FIG. 6.

As shown in FIG. 6, at the time of registration or sale of a ticket, (x) the passenger my receive an email or SMS message as an introduction (B) offering to be a guide or friend in the process: “Hi my name is Jennie and if you would like, I will guide you through the process of selecting activities and be with you through your entire voyage. Would you like that?” The passenger responds (c) with an SMS yes or no. A discourse (d) would follow at the pace that the passenger responds to determine what the passengers likes and dislikes are. This conversation might occur well before the trip and allow diversion to a real human for complex questions. The result of the process of “interest accumulation” (e) is a user profile (f) for the passenger.

The resource availability can then be obtained (g). At the same time, ESN information for the passenger can also be obtained (h) based on the user profile of the passenger and other passengers, as previously described, to determine potential ESNs for the passenger. Based on the ESN information for the passenger and other passengers, an allocation of resources can occur (i) and the passenger can be invited (k) to join specific activities by creating a reservation (l) per an example “event X” (m).

Inducements can accompany the invitations in order to redirect particular passengers to particular activities and maximize use of the various facilities on the cruise ship associated with different activities or events. The types of inducements can be selected based on the ESN information associated with a transition to a particular ESN. Thus, the present disclosure contemplates that some invitations will not include inducements, as the ESN information indicates that such users would transition to a particular ESN anyways.

The chatbot can be used to assure quality and satisfaction via ongoing interactive feedback and evaluation (n). This process may be repeated in the future to assure final satisfaction with the cruise experience with a follow-up conversation (u).

In some situations, resources may be under-utilized. Accordingly, as described above, the conditions can be contrived to direct passengers to the underutilized resource. For example, referring again to FIG. 6, when a passenger is within range of the activity (o) whose resource is available (p) within the passenger's schedule (q) is such that there are no conflicts and the resource is reasonably convenient, a spontaneous invitation (r) with an inducement may be offered for Event Y (s). For example, to redirect passengers to an empty ice cream shop, the chatbot may indicate “this is Jennie—just want to let you know that a second scoop is now free at the ice cream parlor on deck 4—30% off for cherry vanilla.” The type and amount of inducement can be selected based on ESN information associated with the passenger.

As noted above, the scheduling of users should consider groups and activities that should not be combined. In the cruise scenario, the ESN information can be used achieve this goal.

For example, some smokers would not receive inducements to Scuba lessons and indeed might be redirected to conflicting activities on purpose. Such smokers instead might be offered an inducement to travel a distance to the cigar store. However, other smokers already traveling to the smoke shop at that time would not get such an offer or a different offer.

The indolent passenger would not get such an offer and neither would the Baptists, but may still get an inducement to direct them to areas of the cruise ship that separates them from smokers. The redirection for one group or another can be selected based on ESN information.

Baptists would not be notified of dance class opportunities to separate them from dancers. Similarly, Baptists can be redirected away from any other activities they may disapprove of, such a gambling or activities involving consumption of alcohol. Instead, Baptists may get special promotions for Scuba lessons or other activities they approve of, or including other types of users that do not offend their sensibilities. Again, the redirection can be selected based on ESN information for the Baptists.

In a further example, openings in a dance class for polka lessons may go out to the polka dancers but not the swing dancers. However, if the swing dance class is overbooked, the swing dancers might be offered a discount or private attention to learn the Polka instead. The offer and inducement (if any) for the swing dancers can be selected based on their ESN information.

The net effect is that utilization of ESN modeling and scheduling based on ESN information enables a methodology for concerting the activities of disparate groups of users to ensure that usage of a set of resources is maximized while still maintaining proper separation between passenger types and activity types that are not compatible. In the cruise ship scenario, this can translate to greater profits, as passengers are directed to activities of great interest to them, including activities they are more likely to spend money for.

The scenario discussed above has been presented solely for illustrative purpose and the various embodiments are not limited in this regard. Rather, the present disclosure contemplates that the various embodiments can be utilized in any scenario including any number and types of users and any number of resources.

As described above, one aspect of the present technology is the gathering and use of data available from various sources to improve the delivery of advertisements or any other content that may be of interest to users. The present disclosure contemplates that in some instances, this gathered data may include personal information data that uniquely identifies or can be used to contact or locate a specific person. Such personal information data can include demographic data, location-based data, telephone numbers, email addresses, social media IDs such as TWITTER IDs, home addresses, or any other identifying information.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given advertisement or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

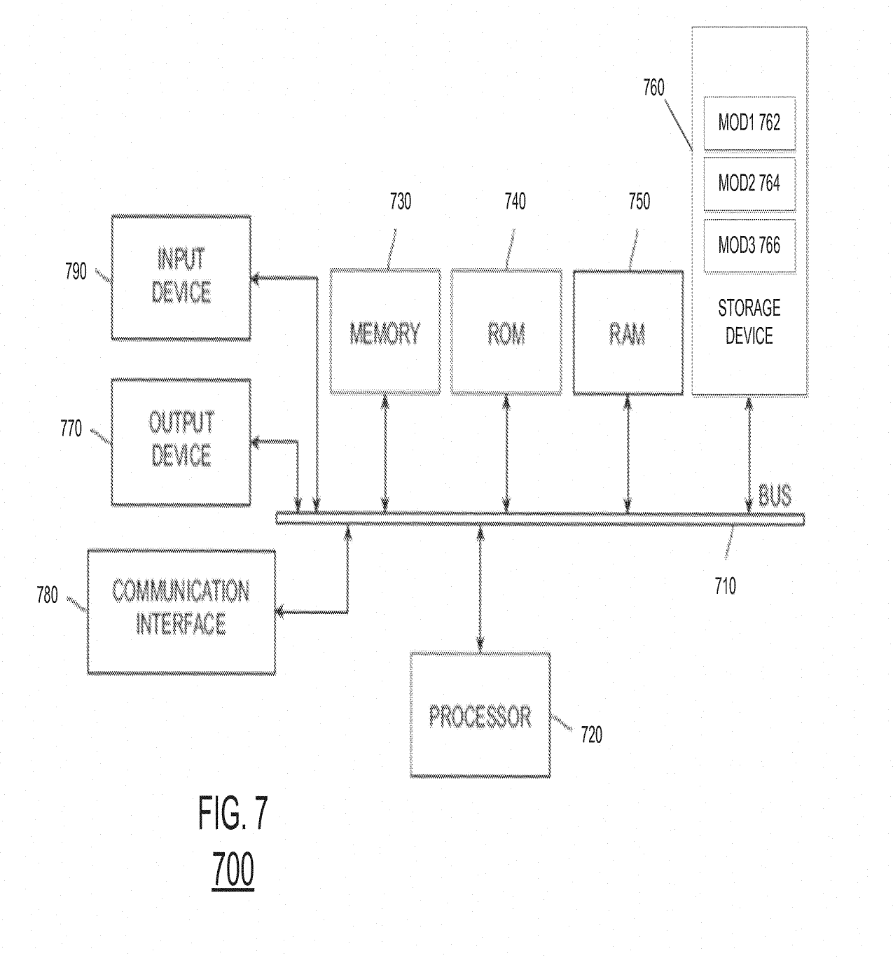

FIG. 7 illustrates an exemplary system 700 that includes a general-purpose computing device 700, including a processing unit (CPU or processor) 720 and a system bus 710 that couples various system components including the system memory 730, such as read only memory (ROM) 740, and random access memory (RAM) 750 to the processor 720. The system 700 can include a cache 722 of high speed memory connected directly with, in close proximity to, or integrated as part of the processor 720. The system 700 copies data from the memory 730 and/or the storage device 760 to the cache 722 for quick access by the processor 720. In this way, the cache 722 provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 7 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules MOD1 762, MOD2 764, MOD3 766 for controlling the processor 720. Other hardware or software modules are contemplated. The storage device 760 is connected to the system bus 710 by a drive interface. The drives and the associated computer-readable storage media provide nonvolatile storage of computer readable instructions, data structures, program modules and other data for the computing device 700. In one aspect, a hardware module that performs a particular function includes the software component stored in a non-transitory computer-readable medium in connection with the necessary hardware components, such as the processor 720, bus 710, output device 770, and so forth, to carry out the function. The basic components are known to those of skill in the art and appropriate variations are contemplated depending on the type of device, such as whether the device 700 is a small, handheld computing device, a desktop computer, or a computer server.

Although the exemplary embodiment described herein employs a hard disk as storage device 760, it should be appreciated by those skilled in the art that other types of computer-readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, may also be used in the exemplary operating environment. Non-transitory computer-readable storage media expressly exclude media such as energy, carrier signals, electromagnetic waves, and signals per se. However, non-transitory computer-readable storage media do include computer-readable storage media that store data only for short periods of time and/or only in the presence of power (e.g., register memory, processor cache, and Random Access Memory (RAM) devices).

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example, the functions of one or more processors presented in FIG. 7 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations discussed below, and random access memory (RAM) 750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 7 can practice all or part of the recited methods, can be a part of the recited systems, and/or can operate according to instructions in the recited non-transitory computer-readable storage media. Such logical operations can be implemented as modules configured to control the processor 720 to perform particular functions according to the programming of the module. For example, FIG. 7 illustrates three modules MOD1 762, MOD2 764 and MOD3 766, which are modules configured to control the processor 720. These modules may be stored on the storage device 760 and loaded into RAM 750 or memory 730 at runtime or may be stored as would be known in the art in other computer-readable memory locations.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method for a partner system to manage at least one entity of interest, comprising:
receiving augmented information for the at least one entity, the augmented information comprising at least an episodic social network (ESN) currently associated with the at least one entity and bounded by a set of finite temporal boundaries and at least one set of non-temporal boundaries, a plurality of future ESNs for the at least one entity from the at least one ESN currently associated with the at least one entity, and future conditions required for transitioning to each of the plurality of future ESNs;
selecting at least one of the plurality of future ESNs based on a selection criteria to yield selected ESNs;
generating the future conditions associated with the selected ESNs based on redirection criteria associated with the partner system.

2. The method of claim 1, further comprising receiving at least one episodic social network model comprising a plurality of ESNs and a plurality of transitions associated with the plurality of ESNs, each of the ESNs associated with a different set of finite temporal boundaries and finite non-temporal boundaries, each of the plurality of transitions associated with a first and a second of the plurality ESNs and identifying conditions for transitioning between the first and the second of the plurality of ESNs.

3. The method of claim 2, wherein the plurality of future ESNs and the future conditions are selected based from the at least one episodic social network model.

4. The method of claim 1, wherein the plurality of future ESNs and the plurality of transitions define a plurality of paths between the ESN currently associated with the at least one entity and each of the plurality of future ESNs.

5. The method of claim 4, wherein the redirection criteria is selected such that the future conditions are biased for any one of the plurality of paths leading to a one of the plurality of future ESNs preferred by the partner system.

6. The method of claim 4, wherein the redirection criteria is selected such that the future conditions are biased for selected ones of the plurality of paths leading to a one of the plurality of future ESNs preferred by the partner system, wherein the selected ones of the plurality of paths are selected based on an efficiency criteria.

7. The method of claim 1, wherein the redirection criteria comprises selecting the selected ESNs from the plurality of future ESNs that provide an advantage to the partner system, an affiliate of the partner system, or a pre-defined entity.

8. The method of claim 7, wherein the advantage is a financial advantage.

9. The method of claim 1, wherein the generating further comprises providing at least one of guidance, an incentive, or a recommendation to the at least one entity for causing the future conditions to occur.

10. The method of claim 9, wherein the selected ESNs comprise at least two of the plurality of future ESNs, and wherein the selecting further comprises ranking the selected ESNs based on a ranking criteria at the partner system.

11. The method of claim 10, wherein the providing comprises biasing the at least one of the guidance, the incentive, or the recommendation for each of the selected ESNs to favor higher ranking ones of the selected ESNs.

12. The method of claim 9, wherein the at least one of guidance, an incentive, or a recommendation is selected to direct the entity to an ESN that is less attractive to the entity but favored at least one of the partner system, an affiliate of the partner system, or a pre-defined entity.

13. The method of claim 1, wherein the at least one of the guidance, the incentive, of the recommendation comprises pursing an association with at least one other entity, and wherein the method further comprises providing at least one of guidance, an incentive, or a recommendation to the at least one other entity to pursue the association.

14. A non-transitory computer-readable medium having stored thereon a plurality of instructions for causing a computer to perform a method comprising:
receiving augmented information for the at least one entity, the augmented information comprising at least an episodic social network (ESN) currently associated with the at least one entity and bounded by a set of finite temporal boundaries and at least one set of non-temporal boundaries, a plurality of future ESNs for the at least one entity from the at least one ESN currently associated with the at least one entity, and future conditions required for transitioning to each of the plurality of future ESNs;
selecting at least one of the plurality of future ESNs based on a selection criteria to yield selected ESNs;
generating the future conditions associated with the selected ESNs based on redirection criteria associated with the partner system.

15. The non-transitory computer-readable medium of claim 14, further comprising additional instruction for causing the computer to receive at least one episodic social network model comprising a plurality of ESNs and a plurality of transitions associated with the plurality of ESNs, each of the ESNs associated with a different set of finite temporal boundaries and finite non-temporal boundaries, each of the plurality of transitions associated with a first and a second of the plurality ESNs and identifying conditions for transitioning between the first and the second of the plurality of ESNs.

16. The non-transitory computer-readable medium of claim 15, wherein the plurality of future ESNs and the future conditions are selected based from the at least one episodic social network model.

17. The non-transitory computer-readable medium of claim 14, wherein the plurality of future ESNs and the plurality of transitions define a plurality of paths between the ESN currently associated with the at least one entity and each of the plurality of future ESNs.

18. The non-transitory computer-readable medium of claim 14, wherein the redirection criteria comprises selecting the selected ESNs from the plurality of future ESNs that provide an advantage to the partner system, an affiliate of the partner system, or a pre-defined entity.

19. The method of claim 14, wherein the generating further comprises providing at least one of guidance, an incentive, or a recommendation to the at least one entity for causing the future conditions to occur.

20. The non-transitory computer-readable medium of claim 14, wherein the at least one of the guidance, the incentive, of the recommendation comprises pursing an association with at least one other entity, and wherein the method further comprises providing at least one of guidance, an incentive, or a recommendation to the at least one other entity to pursue the association.
